(19) United States
(12) Patent Application Publication
(10) Pub. No.: US 2008/0131705 A1
(43) Pub. Date: Jun. 5, 2008

(54) METHOD AND SYSTEM FOR NANOSTRUCTURE PLACEMENT USING IMPRINT LITHOGRAPHY

(75) Inventors: Matthew E. Colburn, Hopewell Junction, NY (US); Yves C. Martin, Ossining, NY (US); Theodore G. van Kessel, Millbrook, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: INTERNATIONAL BUSINESS MACHINES CORPORATION, Armonk, NY (US)

(21) Appl. No.: 11/565,952

(22) Filed: Dec. 1, 2006

(51) Int. Cl. B32B 38/10; B29C 35/00

(52) U.S. Cl. 428/446; 264/134; 425/445; 428/411.1; 977/887

(57) ABSTRACT

A method (and system) of nanostructure placement using imprint lithography, includes applying a mixture containing an additive exhibiting predetermined properties, to a substrate, bringing one of the substrate and a template containing a relief structure into contact with the other of the substrate and the template containing the relief structure, transferring the relief structure of the template into the patternable material, one of curing and fixing the patternable material, and removing the template, thereby leaving a negative of the relief structure of the template.

### BACKGROUND OF THE INVENTION

1. Field of the Invention

The present invention generally relates to a method and apparatus for precise placement of nanostructures and materials, and more particularly to a method and apparatus for precise placement of nanostructures using imprint lithography.

2. Description of the Related Art

Conventional methods and techniques are problematic in precisely placing nano structures and materials.

That is, it is often desirable to be able to place nanoparticles, nanotubes, quantum dots and other extremely small items in a known region or in a known pattern. The conventional techniques have not been able to do so with reliability and precision.

Nanoscale placement of objects is typically accomplished by either self-assembly or by optical lithography. Numerous examples exist of cases where self-assembly fails to provide a means of placement in terms of orientation and location. An example of this includes the difficulty of placing carbon nanotubes at a given lateral position and orientation. Conventional lithography is often limited by the resolution limits of light.

### SUMMARY OF THE INVENTION

In view of the foregoing and other exemplary problems, drawbacks, and disadvantages of the conventional methods and structures, an exemplary feature of the invention is to provide a method which is primarily intended for use with imprint lithography.

Another exemplary feature of the present invention is to provide a method and structure which can place nanoparticles, nanotubes, quantum dots and other extremely small items in a known region or in a known pattern, with extremely high precision and accuracy.

In a first exemplary aspect of the present invention, a method of nanostructure placement using imprint lithography, includes applying a mixture containing an additive exhibiting predetermined properties, to a substrate, bringing one of a substrate and a template containing a relief structure into contact with the other of the substrate and a template containing a relief structure, transferring the relief structure of the template into the patternable material, one of curing and fixing the patternable material, and removing the template leaving a negative of the relief structure of the template. Finally, the patterned material may be processed by chemical or reactive ion etch to leave the material contained in the additive in a useful position and condition.

With the unique and unobvious aspects of the present invention, nanoparticles, nanotubes, nanowires, quantum dots, and other extremely small items can be precisely and accurately placed in a known region or in a known pattern.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates placement of a photoresist 30 containing nanotubes, on the workpiece 20 and alignment of the workpiece 20;

FIG. 2 illustrates an impression of a template 40 in liquid photoresist 30 containing nanotubes, against the workpiece 20;

FIG. 3 illustrates an exposure of the photoresist containing nanotubes through the transparent template 40;

FIG. 4 illustrates the remaining resist structure 30 following the removal of the imprint template 40;

FIG. 5 illustrates a top view of post imprint photoresist structures 30 containing carbon nanotubes after selective etch;

FIG. 5B illustrates a perspective and side view of post imprint photoresist structures 30 containing carbon nanotubes and their relative positions;

FIG. 6A illustrates a top view of post touch-up etch of resist structures 30 containing carbon nanotubes;

FIG. 6B illustrates a schematic side view of post touch-up etch of resist structures containing carbon nanotubes;

FIG. 6C illustrates a perspective view of post touch-up etch of resist structures containing carbon nanotubes and shows the confined, aligned and positioned carbon nanotube;

FIG. 6D illustrates a schematic side view of a pattern after selective etch and the application of connecting structures to the resist structures containing carbon nanotubes;

FIG. 6E illustrates a perspective view of the confined, aligned and positioned carbon nanotube;

FIG. 6F illustrates a schematic side view of a post touch-up etch of resist structures containing carbon nanotubes in which the pattern is constructed to allow selected nanotubes to enter a cavity in the mold;

FIG. 6G illustrates a perspective view of post touch-up etch of resist structures depicted in FIG. 6F containing carbon nanotubes and shows the confined, aligned and positioned carbon nanotube;

FIG. 6H illustrates a side view of the confined, aligned and positioned carbon nanotube after selective etch and rinse;

FIG. 6I illustrates a a perspective view of the confined, aligned and positioned carbon nanotube;

FIG. 6J illustrates a side view of the subsequent processing to add connective structures to the confined, aligned and positioned carbon nanotube;

FIG. 6K illustrates a perspective view of the connected carbon nanotube;

FIG. 7 illustrates a second exemplary embodiment according to the present invention the placement of nanoparticles;

FIG. 8A illustrates a top view of the post etch protection structure containing the nanoparticles according to the second exemplary embodiment of the present invention;

FIG. 8B illustrates a schematic side view of a protection pattern in which the particles are prevented from penetrating into the cavity (recess);

FIG. 8C illustrates a schematic side view of a pattern after selective etch of resist structures containing the additive particles;

FIG. 8D illustrates a perspective view of the confined, aligned and positioned additives;

FIG. 9 illustrates a method 900 according to an exemplary aspect of the present invention.

### DETAILED DESCRIPTION OF EXEMPLARY EMBODIMENTS OF THE INVENTION

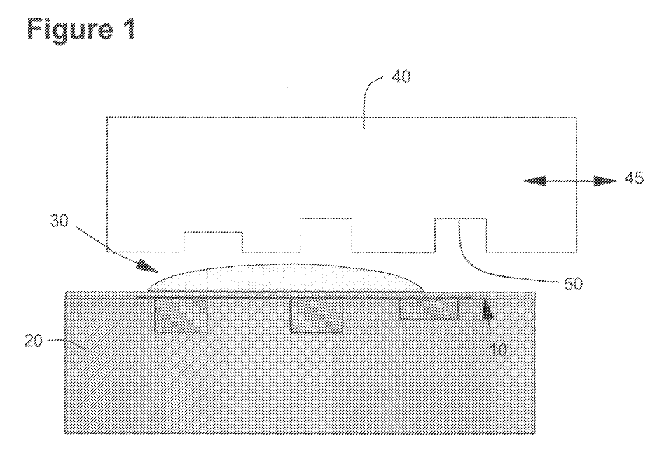

Referring now to the drawings, and more particularly to FIGS. 1-9, there are shown exemplary embodiments of the method and structures according to the present invention.

### Exemplary Embodiment

As mentioned above, the present invention addresses the problem of the precise placement of nano structures and materials. It is often desirable to be able to place nanoparticles, nanotubes, quantum dots and other extremely small items in a known region or in a known pattern.

The present invention takes specific novel advantage of imprint lithography to achieve this goal.

For purposes of the present invention, “imprint lithography” refers to a process of pressing a very small quantity of viscous material between a workpiece (or substrate) and a patterned template (e.g., typically etched quartz), and then curing the material (usually a polymer) by exposure to light (in the case of a photopolymer such as photoresist) through the template or exposing the material to heat, to crosslink and harden the patterned material.

This process characteristically uses minute quantities of photopolymer (e.g., on the order of nanoliters) to cover a an area of hundreds of square millimeters. Handling and placing this small amount of material can be achieved by using a nanoliter injector or the like which may be considered to operate similar to an ink jet or other suitable means.

Adding small amounts of a given trace material of interest (nanotubes, nanowires, radioactive tracer particles, quantum dots etc.) to the small quantity of photopolymer needed to cover a chip size pattern, allows one to achieve large effective concentrations of the trace material added. This is a critical advantage since the trace materials of interest are often expensive and/or only available in extremely small quantities. The patterned photopolymer (e.g., resist) that results thus contains the desired trace material concentration in the pattern at desired locations.

Hereinbelow, two illustrative, exemplary cases will be described including nanotube placement and magnetic particle placement.

### Exemplary Embodiment 1: Nanotube Placement

It has been shown that devices such as field effect transistors (FETs) can be fabricated by fabricating metal contacts at the ends of carbon nanotubes. This work has been done by finding randomly located tubes on a workpiece and then attaching the connections.

In order for these devices to be useful, their lateral placement should be controlled such that arrays and circuits can be reliably be constructed in large quantity. The present invention provides a practical method (and corresponding system) of doing this.

The present invention locates nanostructures using an imprint lithography process to geometrically confine the structures. An advantage to the inventive method is that it precisely locates the structures such that complex arrays and circuits can be constructed using conventional methods. The invention provides:

1. a means to precisely locate nanostructures on a workpiece; and

2. a means to align and place subsequent structure such as metal connections relative to the nanostructures.

These are both important aspects of realizing practical commercial devices.

Turning now to the Figures and more specifically to FIG. 1, in the inventive process, a resist layer 10 is spun onto a workpiece 20 (e.g., a silicon wafer or a substrate with a layer of previously patterned and processed material, or the like). Preferably, the resist layer 10 has a thickness within a range of about 100 nm to about 500 nm.

A small amount (e.g., within a range of about 1 nl to about 100 nl) of photoresist 30 containing an additive (e.g., carbon nanotubes in this exemplary application) is placed on the resist layer 10 of the workpiece 20.

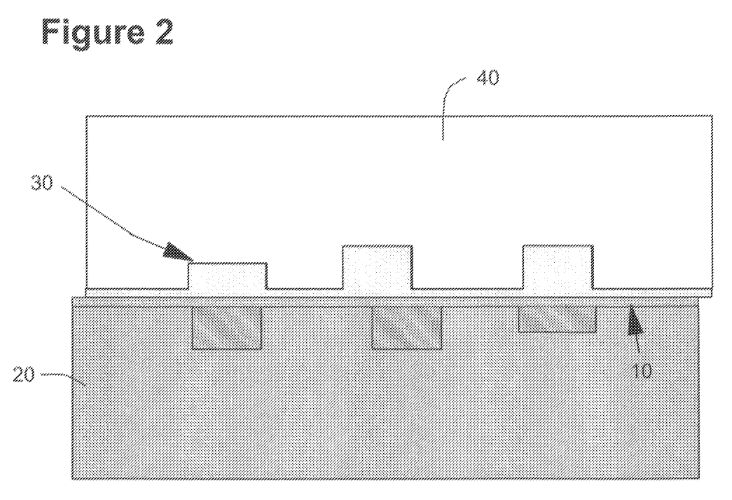

An optically transparent imprint template (e.g., formed of quartz, sapphire or glass etc.) or mold (mask) 40 is then lowered (e.g., movable in the directions of the arrows 45 and perpendicularly thereto) onto the photoresist 30, thereby causing the resist 30 to flow laterally and vertically into the voids 50 in the template 40, as shown in FIG. 2.

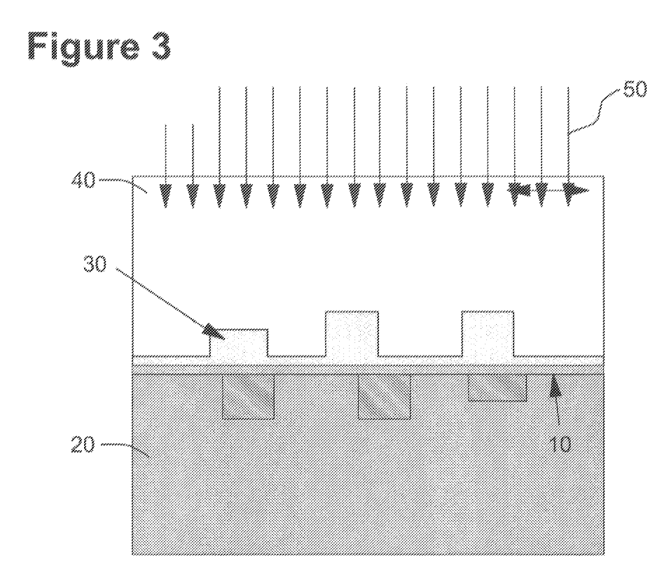

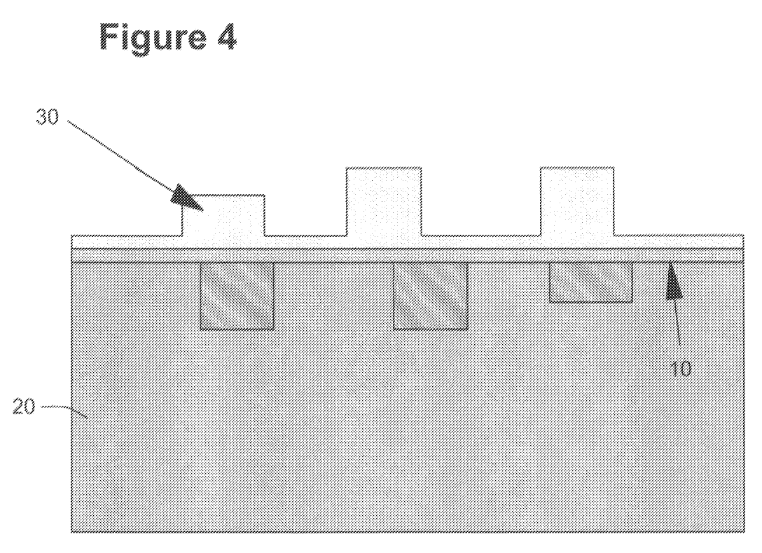

As shown in FIG. 3, the resist 30 is exposed by propagating ultraviolet light 50 through the imprint mask 40 until fully cured. FIG. 4 shows the remaining resist structure following the removal of the imprint template 40.

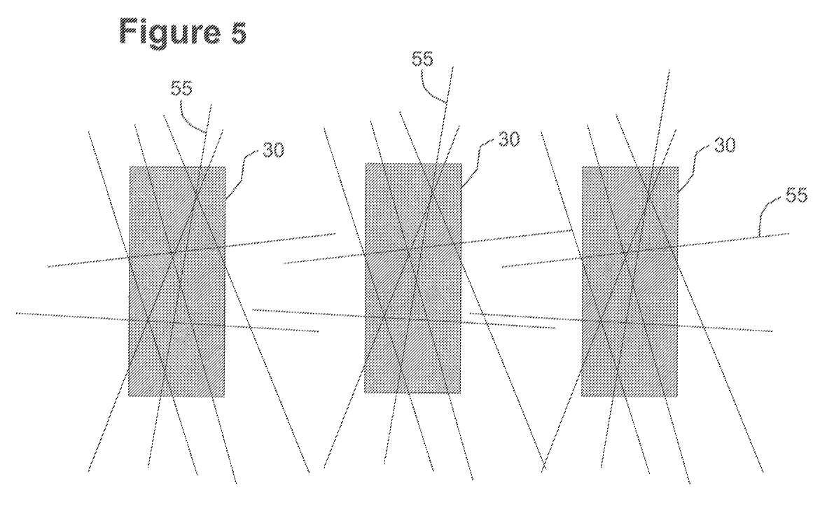

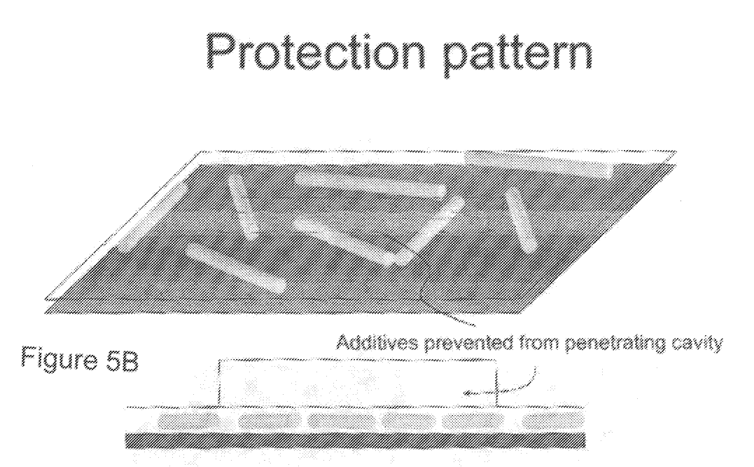

That is, once the resist 30 is cured, a touch-up etch is performed leaving behind discrete regions of photoresist containing carbon nanotubes 55 A top view of this is illustrated in FIG. 5 in which the nanotubes are shown below the resist structures.

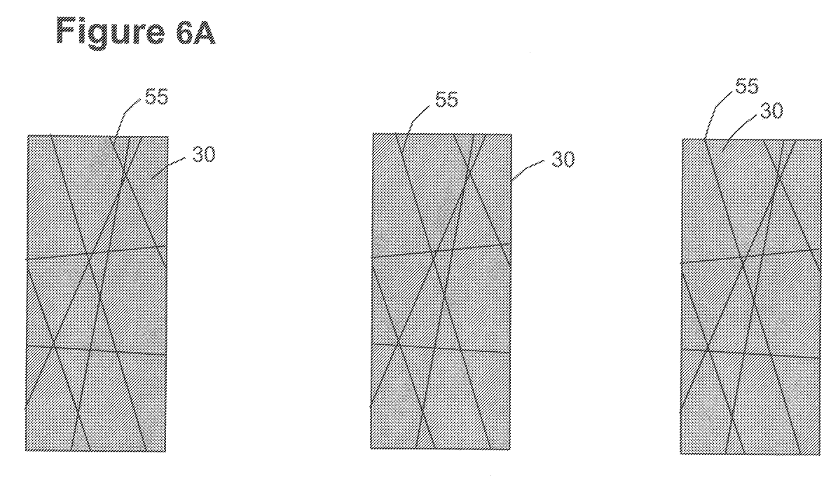

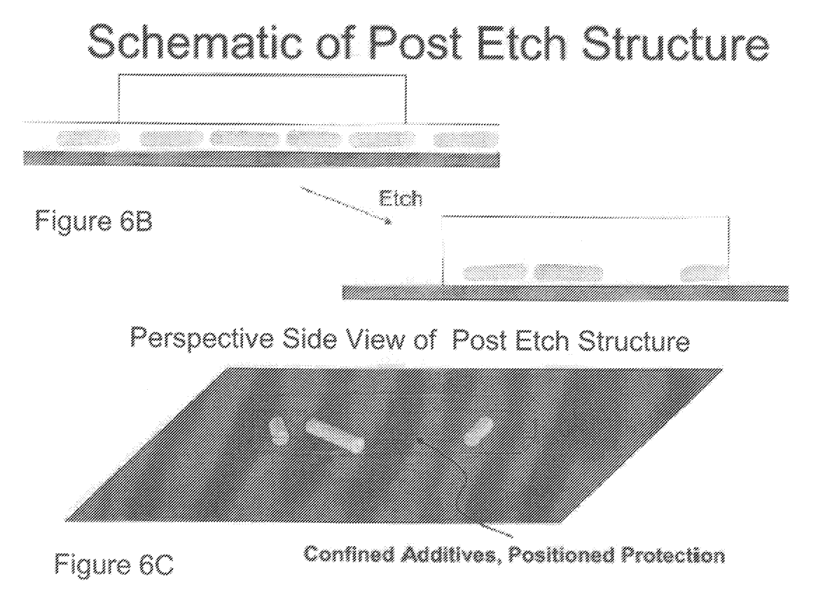

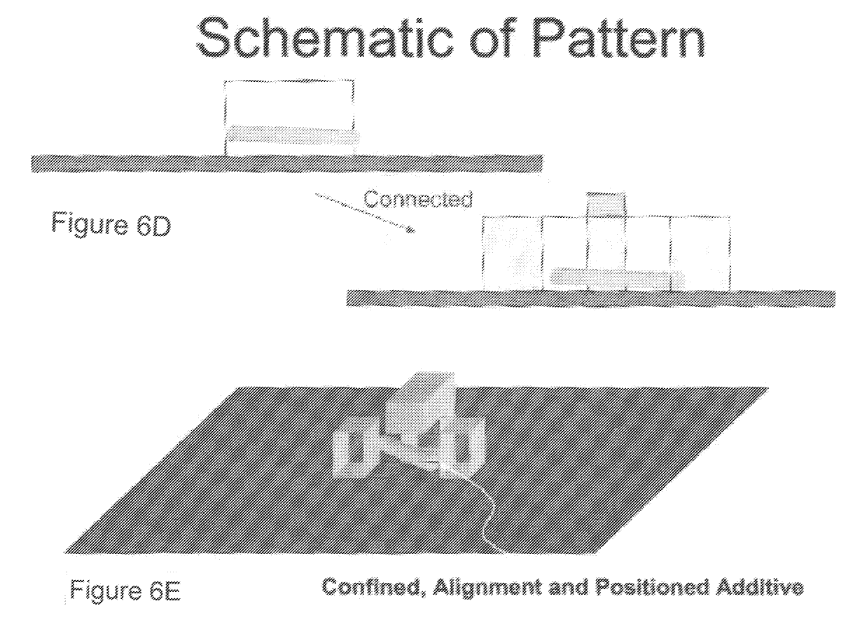

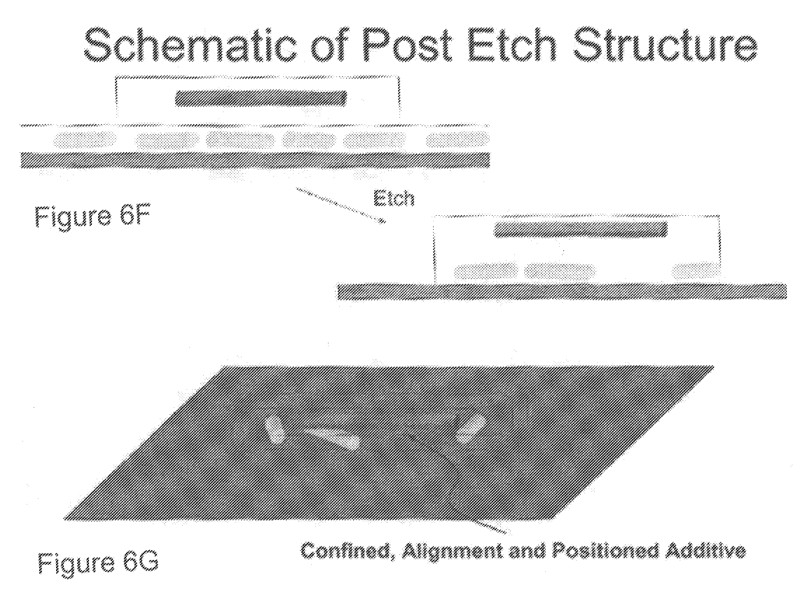

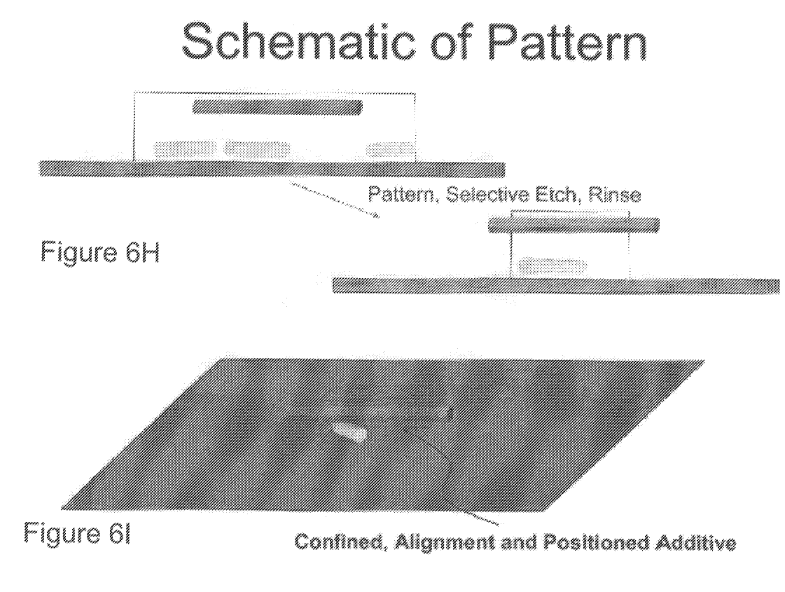

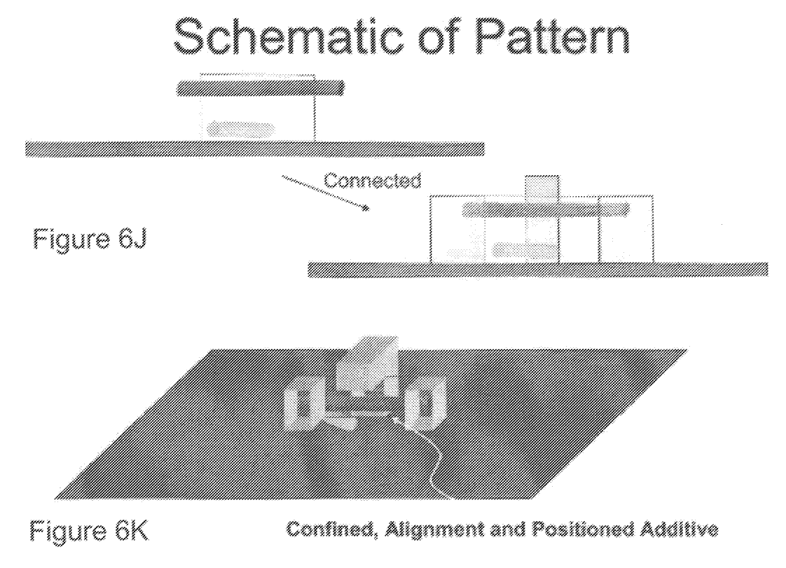

FIG. 5 shows a top view of the post imprint photoresist structures containing carbon nanotubes 55, whereas FIG. 6A is a top view of the post touch-up etch of resist structures containing the carbon nanotubes 55.

FIG. 5B shows a perspective view and side view of the protection pattern and the relative position of the nanotubes relative to the mold structure prior to etch. In this instance, the tubes are spatially excluded from the cavity.

Subsequent processes can expose the ends of the tubes and add metal contacts and connections to form circuits. Thus, for example wires may be placed on the edges of the tubes and one can easily form an array.

FIG. 6B illustrates a schematic side view of post touch-up etch of resist structures containing carbon nanotubes.

FIG. 6C illustrates a perspective view of post touch-up etch of resist structures containing carbon nanotubes and shows the confined, aligned and positioned carbon nanotube (additive).

FIG. 6D illustrates a schematic side view of a pattern after selective etch and the application of connecting structures to the resist structures containing carbon nanotubes.

FIG. 6E illustrates a perspective view of the confined, aligned and positioned carbon nanotube.

FIG. 6F illustrates a schematic side view of a post touch-up etch of resist structures similar to those in FIG. 6B containing carbon nanotubes in which the pattern is constructed to allow selected nanotubes to enter a cavity in the mold.

FIG. 6G illustrates a perspective view of post touch-up etch of resist structures depicted in FIG. 6F containing carbon nanotubes and shows the confined, aligned and positioned carbon nanotube (additive) similar to FIG. 6C.

FIG. 6H illustrates a side view of the confined, aligned and positioned carbon nanotube after selective etch and rinse.

FIG. 6I illustrates a a perspective view of the confined, aligned and positioned carbon nanotube.

FIG. 6J illustrates a side view of the subsequent processing to add connective structures to the confined, aligned and positioned carbon nanotube.

FIG. 6K illustrates a perspective view of the connected carbon nanotube.

### Exemplary Embodiment 2: Magnetic Particle Placement

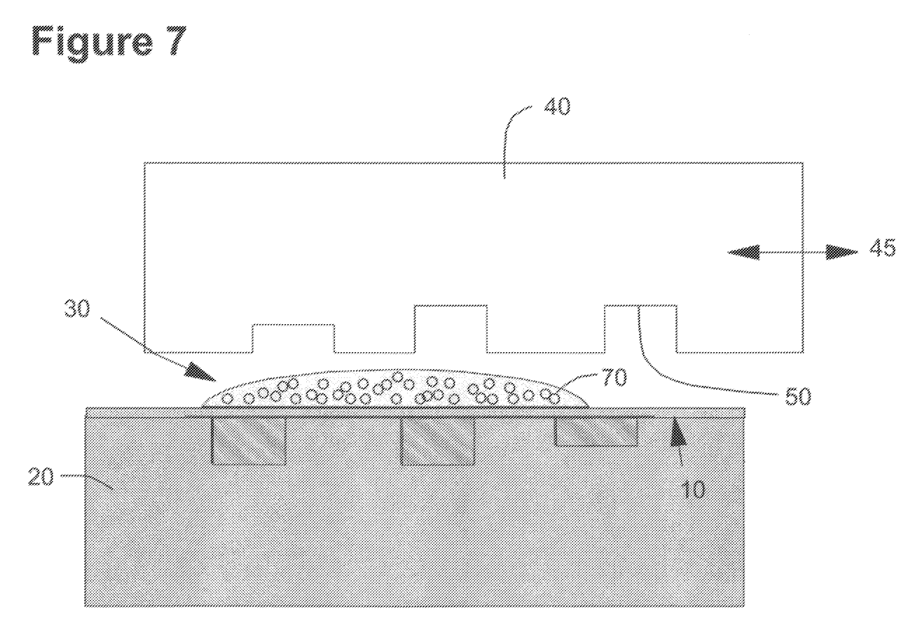

In this second exemplary case, as shown in FIG. 7, magnetic particles 70 of a known size are placed in the photopolymer resist 30.

This resist 30 is patterned using a periodic template 40 similarly as that shown in FIGS. 2 and 3.

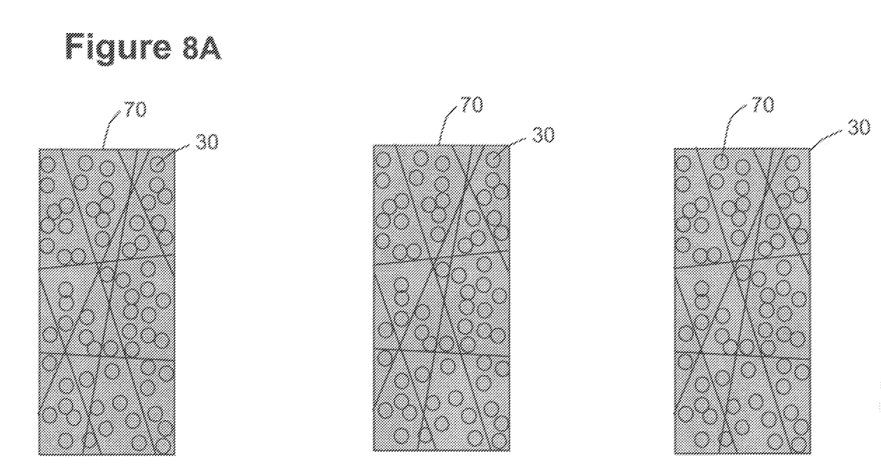

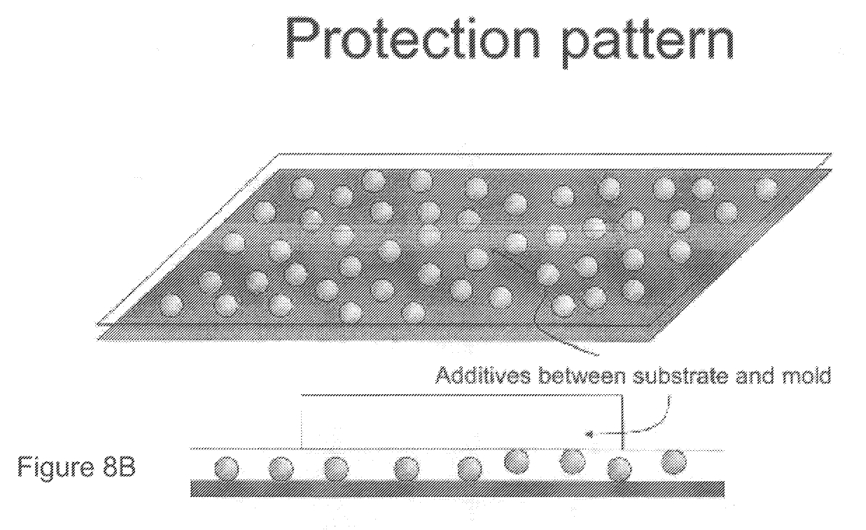

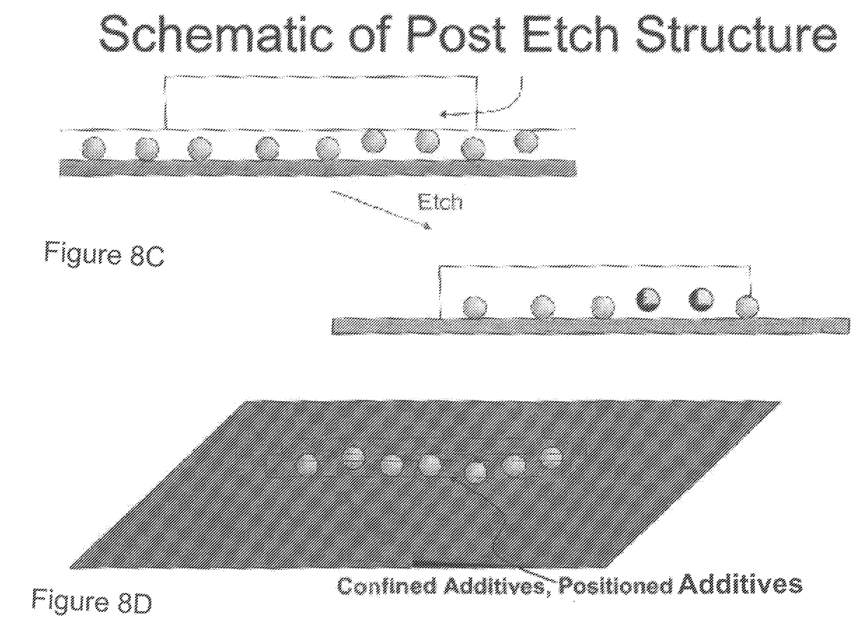

The process of the second embodiment is similar to the first exemplary embodiment, except that in this case the desired magnetic material 70 is left in the resist after the touch-up etch, as shown in FIG. 8A.

The resist containing magnetic particles 70 is patterned by applying the resist, pressing the mold into the resist and exposing the resist to UV illumination to polymerize the resist. This pattern is then subjected to a reactive ion etch (RIE) to leave the material contained in the patterned areas. The resultant periodic pattern forms a discrete magnetic medium.

FIG. 8B illustrates a schematic side view of a protection pattern in which the additives are prevented from penetrating into the cavity (recess).

FIG. 8C illustrates a schematic side view of a pattern after selective etch of resist structures containing the additive.

FIG. 8D illustrates a perspective view of the confined, aligned and positioned additives.

In both of the cases above, nanostructures are created by confining material using imprint lithographic methods. Thus, spatial confinement of the patterned material is a unique attribute of imprint lithography or embossing.

Comparatively, standard material processing such as photolithography and reactive ion etch common in the semiconductor industry utilizes a subtractive method of patterning not conducive to spatial confinement.

By formulating the patterned material formulation with functional additives, the spatial confinement results in preferential localization and/or orientation of the functional additives and hence can result in a pattern material that exhibits novel and unique properties.

The present invention pertains to the areas of semiconductor manufacturing techniques, bio-chip manufacturing techniques, nanotechnology manufacturing techniques, packaging techniques, and exploratory research techniques. Moreover, by spatially confining functional additives, the manufacturing of many applications and products are enabled. The task of spatially confining and position carbon nanotubes is a challenge to researchers developing the next generation of logic devices. By utilizing the spatial confinement of imprint lithography and/or embossing, the development of circuits based on nanotechnology such as carbon nanotubes is thus feasible.

While the two exemplary embodiments of the invention are described above, the present invention is certainly not limited to such examples as would be known by one of ordinary skill in the art.

That is, the inventive techniques discussed above can be generically applied to the conventional imprint lithography techniques and embossing techniques.

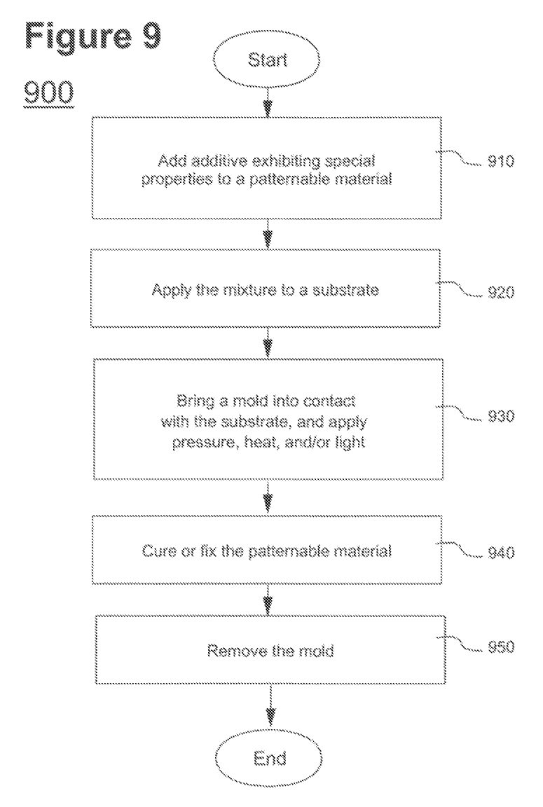

Turning to FIG. 9, which shows a generic method 900 of the invention, as described above, first, in step 910, an additive that exhibits special properties (e.g., carbon nanotubes, magnetic particles, silicon nanowires, germanium nanowires etc.) is added to a patternable material such as a polymer or reactive monomer.

Then, in step 920, this mixture (e.g., preferably in an amount of 10 nl to about 100 nl) is applied to a substrate.

In step 930, a mold containing a desired relief structure is brought into contact with the substrate. Pressure, heat, and/or light is applied to transfer the mold's relief structure into the patternable material.

Thereafter, in step 940, the patternable material is cured or fixed, and in step 950 the mold is removed, thereby leaving the negative of the mold's relief structure.

Depending the size, shape, and type of additive added to the formulation, the mold can be designed accordingly. There are two identifiable exemplary cases that illustrate the mechanism of the inventive process: i) the additive is smaller than the relief structure's characteristic dimension, or ii) the additive is larger than the relief structure's characteristic dimension.

When the additive is smaller than the relief structure's characteristic dimension (as in the magnetic particle placement embodiment described above), the additive is free to enter the cavity of the mold's relief structure and may or may not orient relative to the shape of the relief structure. Some additives not in the recessed regions will be oriented in a plane nominally parallel to the substrate. The orientation of these additives will be randomly distributed angularly about the substrate normal. In this case, the usual intention is that subsequent etching of the substrate will leave the relief structure and eliminate the residual layer. The resultant pattern contains localized structures with known density of functional additives. Patterned magnetic media is an example.

A subcategory of this case (e.g., when the additive is smaller than the relief structure's characteristic dimension) that is of particular interest is when the relief structure has two or more characteristic dimensions (e.g., a rectangular box).

That is, if the additive has a length, L, and width, W<<L, and the box has length, A, and width B, then if B<L<A, the additive is allowed to exist in the rectangular relief only if the additive is aligned nominally lengthwise in the relief structure and is allow to have some angular rotation about the main lengthwise axis.

In a second case (e.g., when the additive is larger than the relief structure's characteristic dimension), the additive is prohibited from entering the relief structure, thereby producing a means of concentrating the additives between the substrate and the nominal surface of the mold. The exemplary embodiment above directed to carbon nanotube placement applies here.

That is, the orientation of the additive will be parallel to the substrate surface, but may be in a random orientation within the plane parallel to the substrate surface. The patterned material that is within the recessed region of the mold thus acts as a mask for the not concentrated functional additives regions. Some additives not in the recessed regions will be oriented in a plane nominally parallel to the substrate. The orientation of these additives will be randomly distributed angularly about the substrate normal.

It is noted that the additive can be any material including expensive or hard to fabricate materials (colloidal gold, quantum dots, etc.).

That is, because of the low volume of additive used, the cost of using such materials will be relatively low. Hence, any useful thing can be placed into the photoresist, and the additive can be aligned (e.g., with wires or the like).

Quantum dots with optical properties or magnetic particles to make a patterned magnetic medium can be produced, which would allow printing down to about 5 nm. Exemplary tests by the present inventors have shown printing to about 50 nm.

With the invention, the amount of photoresist used can be minimized, and the functional materials (additive) can be incorporated in the photoresist and then located through various means.

While the invention has been described in terms of several exemplary embodiments, those skilled in the art will recognize that the invention can be practiced with modification within the spirit and scope of the appended claims.

Further, it is noted that, Applicant's intent is to encompass equivalents of all claim elements, even if amended later during prosecution.

What is claimed is:

1. A method of nanostructure placement using imprint lithography, comprising:
applying a mixture containing an additive exhibiting predetermined properties, to a substrate;
bringing one of the substrate and a template containing a relief structure into contact with the other of said substrate and said template containing the relief structure;
transferring the relief structure of said template into the patternable material;
one of curing and fixing the patternable material; and
removing the template, thereby leaving a negative of the relief structure of the template.

2. The method of claim 1, wherein said mixture includes a patternable material comprising one of a polymer and a reactive monomer.

3. The method of claim 1, wherein said transferring comprises transferring by at least one of pressure, heat, and light.

4. The method of claim 1, wherein a design of said template is dependent upon at least one of a size, a shape, and a type of said additive.

5. The method of claim 4, wherein said additive is smaller than a characteristic dimension of the relief structure.

6. The method of claim 4, wherein the additive is larger than a characteristic dimension of the relief structure.

7. The method of claim 5, wherein the additive is free to enter a recessed region of the relief structure of the template, and
wherein additives not in the recessed region will be oriented in a plane substantially parallel to the substrate, such that an orientation of the additives not in the recessed region randomly distribute angularly about the substrate normal.

8. The method of claim 7, wherein when the relief structure includes two or more characteristic dimensions such that if the additive has a length, L, and width, W<L, and the relief structure has a length, A, and a width B, then if B<L<A, the additive is allowed to exist in the rectangular relief only if the additive is aligned nominally lengthwise in the relief structure and is allowed to have angular rotation about a main lengthwise axis.

9. The method of claim 7, wherein the additives are prohibited from entering the relief structure, such that additives are positioned between the substrate and the surface of the mold.

10. The method of claim 9, wherein an orientation of the additives is parallel to the substrate surface, and randomly oriented within a plane parallel to the substrate surface.

11. The method of claim 10, wherein a patterned material within the recessed region of the mold acts as a mask for the not concentrated functional additives regions, and
wherein additives not in the recessed regions will be oriented in a plane nominally parallel to the substrate and orientations of the additives not in the recessed regions are randomly distributed angularly about the substrate normal.

12. The method of claim 1, further comprising:
adding the additive exhibiting said predetermined properties to a patternable material, to form the mixture.

13. A structure, comprising:
a substrate:
a cured resist layer formed over said substrate and formed to have a predetermined pattern thereon; and
an additive placed on the resist layer having predetermined properties.

14. The structure of claim 13, wherein said additive comprises carbon nanotubes.

15. The structure of claim 13, wherein said additive comprises magnetic particles.

16. The structure of claim 13, wherein said additive comprises silicon nanowires.

17. The structure of claim 13, wherein said additive comprises germanium nanowires.

18. A system of nanostructure placement using imprint lithography, comprising:
means for applying a mixture containing an additive exhibiting predetermined properties, to a substrate;
means for bringing one of a substrate and a template containing a relief structure into contact with the other of said substrate and a template containing a relief structure;
means for transferring the relief structure of said template into the patternable material;
means for one of curing and fixing the patternable material; and
means for removing the template leaving a negative of the relief structure of the template.

19. The system of claim 18, wherein said mixture includes a patternable material comprising one of a polymer and a reactive monomer, and wherein a design of said template is dependent upon at least one of a size, a shape, and a type of said additive.

20. The system of claim 18, wherein said additive comprises one of carbon nanotubes, magnetic particles, silicon nanowires, and germanium nanowires.
